(19) United States
(12) Patent Application Publication
(10) Pub. No.: US 2016/0041658 A1
(43) Pub. Date: Feb. 11, 2016

(54) DISPLAY DEVICE

(71) Applicant: InnoLux Corporation, Jhu-Nan (TW)

(72) Inventors: Chin-Lung TING, Jhu-Nan (TW); Wen-Jyh SAH, Jhu-Nan (TW)

(21) Appl. No.: 14/806,330

(22) Filed: Jul. 22, 2015

(30) Foreign Application Priority Data
Aug. 8, 2014 (TW) 103127322

(51) Int. Cl. G06F 3/047; G02F 1/1335; G09G 5/00; G02B 5/30; G02B 1/14; G02F 1/1333; G02F 1/13363

(52) U.S. Cl. CPC G06F 3/047; G02F 1/13338; G02F 1/133528; G02F 1/13363; G02B 5/3041; G02B 1/14; G09G 5/003; G09G 2300/0426

(57) ABSTRACT

A display device comprises a first substrate, a second substrate, a touch sensing layer, a first polarization layer and a second polarization layer. The second substrate is disposed opposite the first substrate. The touch sensing layer is disposed on the first substrate. The first polarization layer is directly connected to the touch sensing layer through a first adhesive element. The second polarization layer is connected to the side of the second substrate away from the first substrate through a second adhesive element. The thickness of the first polarization layer or second polarization layer is between 5 μm and 50 μm.

### CROSS REFERENCE TO RELATED APPLICATIONS

This Non-provisional application claims priority under 35 U.S.C. §119(a) on Patent Application No(s). 103127322 filed in Taiwan, Republic of China on Aug. 8, 2014, the entire contents of which are hereby incorporated by reference.

### BACKGROUND OF THE INVENTION

1. Field of Invention

The invention relates to a display device and, in particular, to a lightened and thinned display device.

2. Related Art

With the progress of technologies, display devices, such as flat display devices, have been widely applied to various kinds of fields. Flat display devices, having advantages such as compact structure, low power consumption, less weight and less radiation, gradually take the place of cathode ray tube (CRT) display devices, and are widely applied to various electronic products, such as mobile phones, portable multimedia devices, notebooks, tablet computers and other display devices. Generally, a keyboard and mouse are commonly used to manipulate the information device for inputting information. Besides, the touch control technology currently also becomes a popular manipulation method for the information device and brings an intuitive operation. Accordingly, a touch device using the touch control technology can provide a friendly and intuitive interface for the input operation, and therefore users of all ages can manipulate the information device by fingers or a stylus.

In the design of the display device or touch device, lightness and thinness are the important targets for the companies in addition to the requirement of lowering down the cost. By taking a touch device as an example, the conventional design is to dispose the touch sensing electrode on the upper side of the color filter substrate, then dispose the polarizer on the touch sensing electrode and add a protection substrate to protect the touch device from the external object and moisture. However, such kind of design not only can't reduce the whole thickness of the touch device but also will deteriorate the touch sensitivity due to the larger thickness.

Therefore, it is an important subject to provide a display device which has the advantage of lightness and thinness but does not deteriorate in functionality.

### SUMMARY OF THE INVENTION

In view of the foregoing subject, an objective of the invention is to provide a display device which has the advantage of lightness and thinness but does not deteriorate in functionality.

To achieve the above objective, a display device according to the invention comprises a first substrate, a second substrate, a first polarization layer and a second polarization layer. The second substrate is disposed opposite the first substrate. The first polarization layer is directly connected to the first substrate through a first adhesive element. The second polarization layer is connected to the side of the second substrate away from the first substrate through a second adhesive element. The thickness of the first polarization layer or second polarization layer is between 5 μm and 50 μm.

To achieve the above objective, a display device according to the invention comprises a first substrate, a second substrate, a touch sensing layer, a first polarization layer and a second polarization layer. The second substrate is disposed opposite the first substrate. The touch sensing layer is disposed on the first substrate. The first polarization layer is directly connected to the touch sensing layer through a first adhesive element. The second polarization layer is connected to the side of the second substrate away from the first substrate through a second adhesive element. The thickness of the first polarization layer or second polarization layer is between 5 μm and 50 μm.

In one embodiment, the display device is an LCD device, an in-cell touch display device, or an out-cell touch display device.

In one embodiment, the display device is an on-cell touch display device.

In one embodiment, the display device further comprises a protection substrate and a touch sensing layer. The protection substrate is disposed opposite the first substrate. The touch sensing layer is disposed on the side of the protection substrate facing the first substrate and directly connected to the first polarization layer through a third adhesive element.

In one embodiment, the display device further comprises a protection substrate directly connected to the side of the first polarization layer away from the first substrate through a third adhesive element.

In one embodiment, the first polarization layer or the second polarization layer is a single-layer structure.

In one embodiment, the display device further comprises a third substrate disposed on the side of the second polarization layer away from the second substrate.

In one embodiment, the display device further comprises an optical film disposed on the side of the second polarization layer away from the second substrate.

In one embodiment, the display device further comprises a compensation film disposed between the second substrate and the second polarization layer.

Summarily, in the display device of this invention, the first polarization layer is directly connected to the first substrate through the first adhesive element and the second polarization layer is connected to the side of the second substrate away from the first substrate through the second adhesive element, and besides, the thickness of the first polarization layer or second polarization layer is between 5 μm and 50 μm. Thereby, in comparison with the conventional art, the additional protection substrate is only disposed on the outer side of the first polarization layer to protect the first polarization layer, not disposed on the two sides of the first polarization layer to protect the first polarization layer of the display device of this invention, and the optical film is only added on the second polarization layer or on the outer side of the second polarization layer. Therefore, the display device can have the advantages of lightness and thinness and still functions well.

In some embodiments, the touch sensing layer is disposed on the side of the protection substrate facing the first substrate, and can be directly connected to the first polarization layer through the third adhesive element, or the touch sensing layer can be directly disposed on the first substrate, or the touch sensing layer can be directly disposed on the second substrate, so that the display device becomes an out-cell, an on-cell or an in-cell touch display device. Thereby, in addition to the advantages of lightness and thinness, the display device also can have a better touch sensitivity due to the less thickness.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a display device of an embodiment of the invention;

FIG. 1B is a schematic diagram of a display device of another embodiment of the invention;

FIG. 2A is a schematic diagram of a display device of another embodiment of the invention; and

FIGS. 2B and 2C are schematic diagrams of the display devices according to different embodiments of the invention.

### DETAILED DESCRIPTION OF THE INVENTION

The present invention will be apparent from the following detailed description, which proceeds with reference to the accompanying drawings, wherein the same references relate to the same elements.

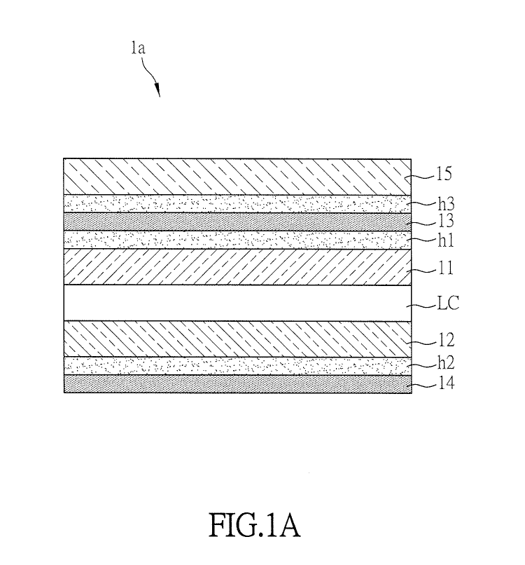

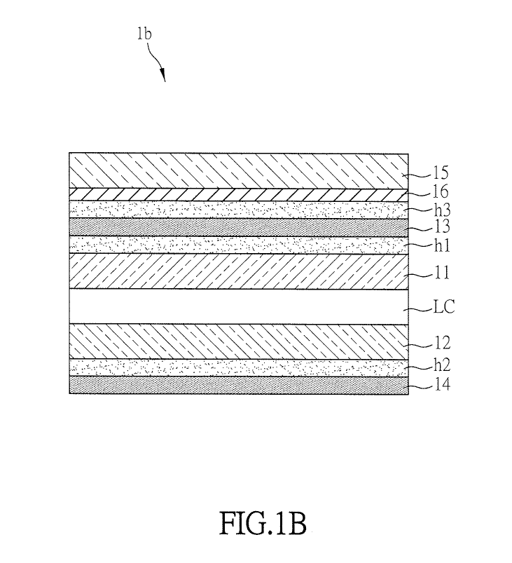

FIG. 1A is a schematic diagram of a display device 1a of an embodiment of the invention.

As shown in FIG. 1A, the display device 1a includes a first substrate 11, a liquid crystal layer LC, a second substrate 12, a first polarization layer 13 and a second polarization layer 14. Moreover, the display device 1a further includes a first adhesive element h1 and a second adhesive element h2. Herein for example, the display device 1a is a liquid crystal display device. In other embodiments, the display device is, for example but not limited to, a smart phone, a tablet computer, a notebook computer, a GPS device or another kind of display device.

The first substrate 11 and the second substrate 12 are disposed oppositely. The liquid crystal layer LC is disposed between the first substrate 11 and the second substrate 12. The first substrate 11 and the second substrate 12 can be made by transparent material, and can be a glass substrate, quartz substrate or plastic substrate for example. The display device 1a can further include a thin film transistor (TFT) array, a color filter (CF) array and a black matrix layer (not shown). The TFT array is disposed on the second substrate 12, and the CF array or the black matrix layer can be disposed on the first substrate 11 or the second substrate 12, so as to form a liquid crystal display (LCD) panel. The TFT array, the CF array and the liquid crystal layer LC can from a pixel array. In one embodiment, the black matrix layer and the CF array can be disposed on the first substrate 11. However, in other embodiments, the black matrix layer or the CF array can be disposed on the second substrate 12 to form a BOA (BM on array) substrate or a COA (color filter on array) substrate. However, this invention is not limited thereto. Moreover, the display device la can further include a plurality of scan lines and a plurality of data lines (not shown), both of which cross each other, perpendicularly for example, to define the area of the pixel array. Besides, the display device 1a can further include a backlight module (not shown), and when the light emitted by the backlight module passes through the LCD panel, the pixels of the display device la can display colors to form images.

The first polarization layer 13 is directly connected to the first substrate 11 through the first adhesive element h1, and the second polarization layer 14 is connected to the side of the second substrate 12 away from the first substrate 11 through the second adhesive element h2. In this embodiment, the first polarization layer 13 is directly connected to the upper surface of the first substrate 11 through the first adhesive element h1, and the second polarization layer 14 is connected to the lower surface of the second substrate 12 away from the first substrate 11 through the second adhesive element h2. Besides, the first polarization layer 13 and the second polarization layer 14 are both a single-layer structure. The first polarization layer 13 and the second polarization layer 14 are both made of the single-direction polarization material, such as polyvinyl alcohol (PVA), but this invention is not limited thereto. The thickness of the first polarization layer 13 and/or second polarization layer 14 can be between 5 μm and 50 μm and favorably between 12 μm and 30 μm.

The display device la of this embodiment can further include a protection substrate 15, which is directly connected to the side of the first polarization layer 13 away from the first substrate 11 through a third adhesive element h3. The material of the protection substrate 15 can be, for example but not limited to, glass or polyethylene terephthalate (PET), or can be other materials. Each of the first adhesive element h1, the second adhesive element h2 and the third adhesive element h3 can be an optical clear adhesive (OCA) or a pressure sensitive adhesive (PSA), but this embodiment is not limited thereto.

To be noted, the term “directly connected” above-mentioned indicates that no other films or elements exist between the first polarization layer 13 and the first substrate 11, between the first polarization layer 13 and the protection substrate 15 and between the second polarization layer 14 and the second substrate 12, in addition to the first adhesive element h1, the second adhesive element h2 and third adhesive element h3.

In a conventional LCD device, a polarizer is generally disposed on a side of each of the CF substrate and the TFT substrate. The polarizer contains the hydrophilic polarization material, and the function of the polarizer may be affected due to that the polarization material may easily generate chemical reactions with the moisture. Therefore, a protection film (such as triacetyl cellulose, TAC) will be disposed on each of the two sides of the polarization material, and then a protection substrate is used to protect the display device. However, this embodiment is to use the protection substrate 15 to protect the display device 1a after the first polarization layer 13 is directly connected to the first substrate 11, so that the thicknesses of the first polarization layer 13 and second polarization layer 14 are both between 5 μm and 50 μm. Accordingly, in comparison with the conventional art, the additional protection films are not used to be disposed on the two sides of the first polarization layer 13 to protect the first polarization layer 13 of the display device 1a of this embodiment, so that the thicknesses of the first polarization layer 13 and second polarization layer 14 are both between 5 μm and 50 μm. Therefore, the display device 1a can have the advantages of lightness and thinness and still functions well.

FIG. 1B is a schematic diagram of a display device 1b of another embodiment of the invention. As shown in FIG. 1B, the display device 1b of this embodiment is an out-cell touch display device, such as an OGS touch display device.

The main difference from the display device 1a is that the display device 1b can further include a touch sensing layer 16. The touch sensing layer 16 is disposed on the side of the protection substrate 15 facing the first substrate 11 and directly connected to the first polarization layer 13 through the third adhesive element h3. The touch sensing layer 16 can include a plurality of driving electrodes and a plurality of sensing electrodes (the so-called Tx and Rx, not shown). Moreover, the protection substrate 15 can be a cover lens.

Since other technical features of the display device 1b can be comprehended by referring to the display device 1a, the related illustration is omitted here for conciseness.

To be noted, in other embodiments, the touch sensing layer 16 may be directly disposed on the second substrate 12, so that the display device becomes an in-cell touch display device.

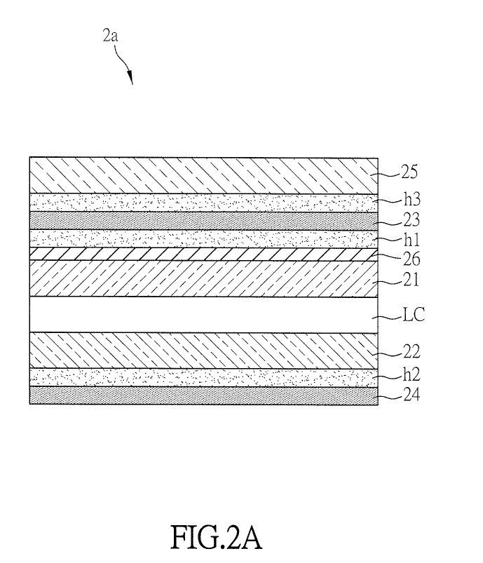

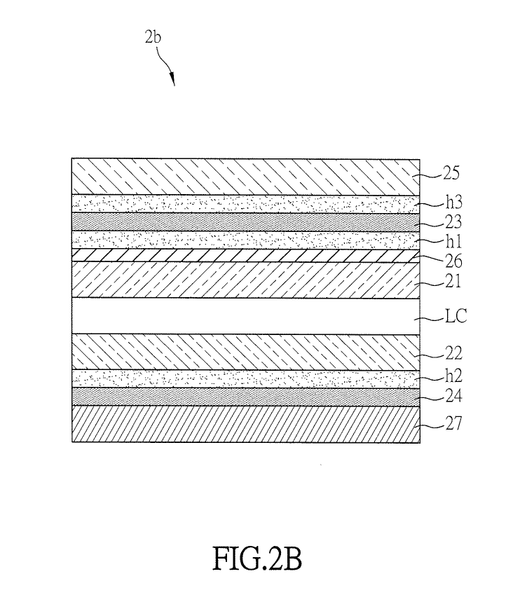

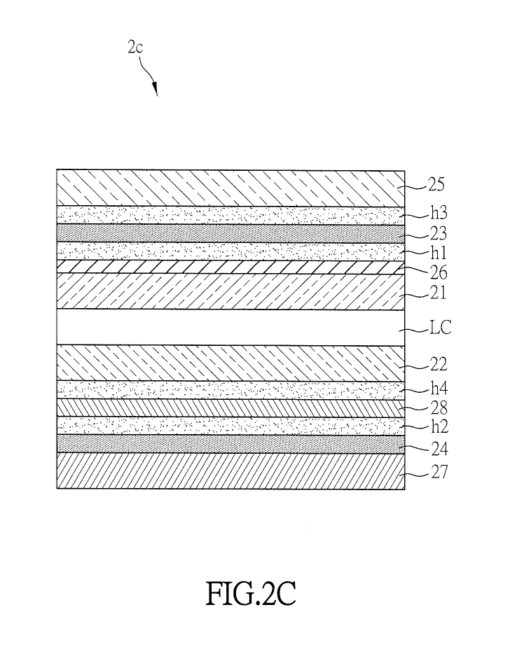

FIG. 2A is a schematic diagram of a display device 2a of another embodiment of the invention. As shown in FIG. 2A, the display device 2a of this embodiment is an on-cell touch display device, or called the TOD (touch on display) touch display device.

The display device 2a includes a first substrate 21, a liquid crystal layer LC, a second substrate 22, a touch sensing layer 26, a first polarization layer 23 and a second polarization layer 24. Besides, the display device 2a further includes a first adhesive element h1, a second adhesive element h2, a third adhesive element h3 and a protection substrate 25. The arrangement and technical features of the first substrate 21, liquid crystal layer LC and second substrate 22 can be comprehended by referring to the first substrate 11, liquid crystal layer LC and second substrate 12 of the display device 1a, and therefore the related illustration is omitted here for conciseness. Moreover, the display device 2a can further include a backlight module (not shown). When the backlight module emits the light passing through the LCD panel, the pixels of the display device 2a can display colors to form images.

The touch sensing layer 26 is disposed on the first substrate 21. The touch sensing layer 26 can include a plurality of driving electrodes and a plurality of sensing electrodes (the so-called Tx and Rx, not shown) and can be formed directly on the first substrate 21 by deposition or coating. The first polarization layer 23 is directly connected to the touch sensing layer 26 by the first adhesive element h1, and the second polarization layer 24 is connected to the side of the second substrate 22 away from the first substrate 21 through the second adhesive element h2. In this embodiment, the first polarization layer 23 is directly connected to the touch sensing layer 26 by the first adhesive element h1, and the second polarization layer 24 is directly connected to the lower surface of the second substrate 22 through the second adhesive element h2. Besides, the first polarization layer 23 and the second polarization layer 24 are both a single-layer structure. The first polarization layer 23 and the second polarization layer 24 are both made by single-direction polarization material, such as polyvinyl alcohol (PVA), but this invention is not limited thereto. The thickness of the first polarization layer 23 and/or second polarization layer 24 can be between 5 μm and 50 μm and favorably between 12 μm and 30 μm.

The protection substrate 25 is directly connected to the side of the first polarization layer 23 away from the first substrate 21 through the third adhesive element h3. Herein, the protection substrate 25 is directly connected to the upper surface of the first polarization layer 23 through the third adhesive element h3. The material of the protection substrate 25 is, for example but not limited to, glass or polyethylene terephthalate (PET). Each of the first adhesive element h1, the second adhesive element h2 and the third adhesive element h3 can be an optical clear adhesive (OCA) or a pressure sensitive adhesive (PSA), but this invention is not limited thereto.

According to the structure of FIG. 2A, in comparison with the conventional art, the additional protection films are not used to be disposed on the two sides of the first polarization layer 23 to protect the first polarization layer 23 of the display device 2a, so that the thicknesses of the first polarization layer 23 and second polarization layer 24 are both between 5 μm and 50 μm. Therefore, the display device 2a has the advantages of lightness and thinness. Besides, since the display device 2a has a less thickness, it can have a better touch sensitivity.

FIGS. 2B and 2C are schematic diagrams of the display devices 2b, 2c according to different embodiments of the invention.

As shown in FIG. 2B, the main difference from the display device 2a is that the display device 2b further includes a third substrate 27, which is disposed on the side of the second polarization layer 24 away from the second substrate 22. Herein the material of the third substrate 27 is triacetyl cellulose (TAC) or poly-methylmethacrylate (PMMA), but this invention is not limited thereto. However, in other embodiments, the third substrate 27 may be replaced by an optical film (not shown), which can be, for example, a brightness enhancement film (BEF) and an advanced polarization conversion film (APCF), and thereby the brightness of the light emitted to the display panel can be enhanced. If the above optical film is used, the BEF is not required for the backlight module.

Furthermore, in order to meet the requirement of the wide viewing angle, as shown in FIG. 2C, the main difference from the display device 2b is that the display device 2c of this embodiment can further include a compensation film 28, which is disposed between the second substrate 22 and the second adhesive element h2 (or the second polarization layer 24). Herein, the compensation film 28 is disposed on the side of the second substrate 22 away from the first substrate 21 through a fourth adhesive element h4, so that the display device 2c can be applied to the LCD panel of VA type, TN type or IPS type for example.

Since other technical features of the display devices 2b, 2c can be comprehended by referring to the display device 2a, the related illustration is omitted here for conciseness.

Summarily, in the display device of this invention, the first polarization layer is directly connected to the first substrate through the first adhesive element and the second polarization layer is connected to the side of the second substrate away from the first substrate through the second adhesive element, and besides, the thickness of the first polarization layer or second polarization layer is between 5 μm and 50 μm. Thereby, in comparison with the conventional art, the additional protection films are not used to be disposed on the two sides of the first polarization layer to protect the first polarization layer of the display device of this invention, but the additional protection substrate is used to be disposed on the outer side of the first polarization layer to protect the first polarization layer, or the optical film is added on the second polarization layer or the outer side of the second polarization layer. Therefore, the display device can have the advantages of lightness and thinness and functions well.

In some embodiments, the touch sensing layer is disposed on the side of the protection substrate facing the first substrate, and can be directly connected to the first polarization layer through the third adhesive element, or the touch sensing layer can be directly disposed on the first substrate, or the touch sensing layer can be directly disposed on the second substrate, so that the display device becomes an out-cell, an on-cell or an in-cell touch display device. Thereby, in addition to the advantages of lightness and thinness, the display device also can have a better touch sensitivity due to the less thickness.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a first substrate;
a second substrate disposed opposite the first substrate;
a first polarization layer directly connected to the first substrate through a first adhesive element; and
a second polarization layer connected to a side of the second substrate away from the first substrate through a second adhesive element,
wherein the thickness of the first polarization layer or the second polarization layer is between 5 μm and 50 μm.

2. The display device as recited in claim 1, which is an LCD device, an in-cell touch display device, or an out-cell touch display device.

3. The display device as recited in claim 1, further comprising:
a protection substrate disposed opposite the first substrate; and
a touch sensing layer disposed on a side of the protection substrate facing the first substrate and directly connected to the first polarization layer through a third adhesive element.

4. The display device as recited in claim 1, further comprising:
a protection substrate directly connected to a side of the first polarization layer away from the first substrate through a third adhesive element.

5. The display device as recited in claim 1, wherein the first polarization layer or the second polarization layer is a single-layer structure.

6. The display device as recited in claim 1, further comprising:
a third substrate disposed on the side of the second polarization layer away from the second substrate.

7. The display device as recited in claim 1, further comprising:
an optical film disposed on the side of the second polarization layer away from the second substrate.

8. The display device as recited in claim 1, further comprising:
a compensation film disposed between the second substrate and the second polarization layer.

9. A display device, comprising:
a first substrate;
a second substrate disposed opposite the first substrate;
a touch sensing layer disposed on the first substrate;
a first polarization layer directly connected to the touch sensing layer through a first adhesive element; and
a second polarization layer connected to a side of the second substrate away from the first substrate through a second adhesive element,
wherein the thickness of the first polarization layer or the second polarization layer is between 5 μm and 50 μm.

10. The display device as recited in claim 9, which is an on-cell touch display device.

11. The display device as recited in claim 9, further comprising:
a protection substrate directly connected to a side of the first polarization layer away from the first substrate through a third adhesive element.

12. The display device as recited in claim 9, wherein the first polarization layer or the second polarization layer is a single-layer structure.

13. The display device as recited in claim 9, further comprising:
a third substrate disposed on a side of the second polarization layer away from the second substrate.

14. The display device as recited in claim 9, further comprising:
an optical film disposed on a side of the second polarization layer away from the second substrate.

15. The display device as recited in claim 9, further comprising:
a compensation film disposed between the second substrate and the second polarization layer.
